(19) United States
(12) Patent Application Publication
(10) Pub. No.: US 2022/0207282 A1
(43) Pub. Date: Jun. 30, 2022

(54) EXTRACTING REGIONS OF INTEREST FOR OBJECT DETECTION ACCELERATION IN SURVEILLANCE SYSTEMS

(71) Applicant: Fortinet, Inc., Sunnyvale, CA (US)

(72) Inventors: Xihua Dong, San Jose, CA (US); Jie Huang, Campbell, CA (US); Yongsheng Liu, Santa Clara, CA (US)

(73) Assignee: Fortinet, Inc., Sunnyvale, CA (US)

(21) Appl. No.: 17/135,887

(22) Filed: Dec. 28, 2020

(51) Int. Cl. G06K 9/32; G06N 20/00; G06T 5/00; G06K 9/00; G06K 9/62

(52) U.S. Cl. CPC G06K 9/3241; G06N 20/00; G06T 5/002; G06K 9/00771; G06T 2207/20132; G06K 9/00255; G06K 9/00288; G06T 2207/20081; G06K 9/6223

(57) ABSTRACT

Systems and methods for accelerated object detection in a surveillance system are provided. According to an embodiment, video frames captured by a camera are received by a processing resource of a surveillance system. Pixels of each video frame are partitioned into cells each representing a rectangular block of the pixels. The background cells within a particular video frame are estimated by comparing each of the cells of the particular video frame to a corresponding cell of other video frames. A number of ROIs within the particular video frame is detected by: (i) identifying active cells within the particular video frame based on the estimated background cells; and (ii) identifying the number of clusters of cells within the particular video frame by clustering the active cells. Then, object detection is caused to be performed within the number of ROIs by feeding the number of ROIs to a machine learning model.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2020, Fortinet, Inc.

### BACKGROUND

### Field

Embodiments of the present disclosure generally relate to object detection in video frames. In particular, embodiments of the present disclosure relate to pre-detection of regions of interest (ROIs) within a video frame to facilitate accelerated object detection in surveillance systems by feeding only the ROIs to an object detection deep neural network (DNN).

### Description of the Related Art

Video analytics, also known as video content analysis or intelligent video analytics, may be used to automatically detect objects or otherwise recognize temporal and/or spatial events in videos. Video analytics is used in several applications. Non-limiting examples of video analytics include detecting suspicious persons, facial recognition, traffic monitoring, home automation and safety, healthcare, industrial safety, and transportation. An example of object detection in the context of surveillance systems is face detection. Depending upon the nature of the surveillance system at issue, feeds from a number of video cameras may need to be reviewed and analyzed.

### SUMMARY

Systems and methods are described for accelerated object detection in a surveillance system. According to an embodiment, multiple video frames captured by a video camera are received by one or more processing resources associated with a surveillance system. The pixels of each video frame are partitioned into multiple cells each representing an X×Y rectangular block of the pixels. The background cells within a particular video frame of the multiple video frames are estimated by comparing each of the cells of the particular video frame to a corresponding cell of one or more other video frames. A number of regions of interest (ROIs) within the particular video frame is then detected by: (i) identifying active cells within the particular video frame based on the estimated background cells; and (ii) identifying the number of clusters of cells within the particular video frame by clustering the active cells. Then, object detection is caused to be performed within the number of ROIs by feeding the number of ROIs to a machine learning model.

Other features of embodiments of the present disclosure will be apparent from accompanying drawings and detailed description that follows.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description applies to any one of the similar components having the same first reference label irrespective of the second reference label.

FIG. 1A illustrates an example network environment in which an object detection system is deployed for accelerated processing in accordance with an embodiment of the present disclosure.

FIG. 1B illustrates the deployment of an object detection system on an edge device for accelerated processing in accordance with an embodiment of the present disclosure.

FIG. 2 illustrates functional modules of an object detection system in accordance with an embodiment of the present disclosure.

FIG. 3 is a block diagram illustrating functional blocks for regions of interest identification, in accordance with an embodiment of the present disclosure.

FIG. 4 illustrates grid cells created for further analysis in accordance with an embodiment of the present disclosure.

FIG. 5 is an example of active cells identified in accordance with an embodiment of the present disclosure.

FIG. 6 illustrates the extraction of a predetermined number of regions of interest (ROIs) by cropping clusters of active cells and merging overlapping regions as appropriate in accordance with an embodiment of the present disclosure.

FIG. 7 illustrates an example application of the object detection system in accordance with an embodiment of the present disclosure.

FIG. 8 illustrates an example process flow for extracting ROIs in accordance with an embodiment of the present disclosure.

FIG. 9 is a flow diagram illustrating accelerated object detection processing in accordance with an embodiment of the present disclosure.

FIG. 10 illustrates an exemplary computer system in which or with which embodiments of the present disclosure may be utilized.

### DETAILED DESCRIPTION

Systems and methods for accelerated object detection in a surveillance system are described. Machine learning, particularly the development of deep learning models (e.g., Deep Neural Networks (DNNs)), has revolutionized video analytics. The processing time of a typical object detection algorithm (e.g., face detection) is proportional to the target image size. For example, a widely used face detection system, the Multi-Task Cascaded Convolutional Networks (MTCNN) framework, takes about one second to process a Full High Definition (FHD) image (e.g., a 1920×1080 pixel image). Object detection performance becomes a bottleneck for video analytics pipelines (e.g., a facial recognition pipeline).

Embodiments of the present disclosure seek to improve object detection speed, for example, in the context of surveillance systems. The background of video footage captured by security surveillance systems is slow-varying, and activities of persons in the foreground are typically the “events” of interest in the context of surveillance systems. Various embodiments take advantage of these characteristics to pre-detect the active areas (the ROIs) within video frames and then feed the ROIs to the object detection DNN. An object detection DNN performs significantly faster when only the ROIs are passed to it. The technique of the proposed disclosure dramatically reduces the computational cost of an object detection pipeline.

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

In the following description, numerous specific details are set forth in order to provide a thorough understanding of example embodiments. It will be apparent, however, to one skilled in the art that embodiments described herein may be practiced without some of these specific details

### Terminology

Brief definitions of terms used throughout this application are given below.

The terms “connected” or “coupled” and related terms are used in an operational sense and are not necessarily limited to a direct connection or coupling. Thus, for example, two devices may be coupled directly or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

As used herein, a “surveillance system” or a “video surveillance system” generally refers to a system including one or more video cameras coupled to a network. The audio and/or video captured by the video cameras may be live monitored and/or transmitted to a central location for recording, storage, and/or analysis. In some embodiments, a network security appliance may perform video analytics on video captured by a surveillance system and may consider being part of the surveillance system.

As used herein, a “network security appliance” or a “network security device” generally refers to a device or appliance in virtual or physical form that is operable to perform one or more security functions. Some network security devices may be implemented as general-purpose computers or servers with appropriate software operable to perform one or more security functions. Other network security devices may also include custom hardware (e.g., one or more custom Application-Specific Integrated Circuits (ASICs)). A network security device is typically associated with a particular network (e.g., a private enterprise network) on behalf of which it provides one or more security functions. The network security device may reside within the particular network that it is protecting, or network security may be provided as a service with the network security device residing in the cloud. Non-limiting examples of security functions include authentication, next-generation firewall protection, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Secure (IPsec), TLS, SSL), application control, Voice over Internet Protocol (VoIP) support, Virtual Private Networking (VPN), data leak prevention (DLP), antispam, antispyware, logging, reputation-based protections, event correlation, network access control, vulnerability management, and the like. Such security functions may be deployed individually as part of a point solution or in various combinations in the form of a unified threat management (UTM) solution. Non-limiting examples of network security appliances/devices include network gateways, VPN appliances/gateways, UTM appliances (e.g., the FORTIGATE family of network security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), and DoS attack detection appliances (e.g., the FORTIDDOS family of DoS attack detection and mitigation appliances).

Due to face detection and recognition being a primary use of object detection, the examples and experiments described herein are focused on human face detection and recognition. However, those skilled in the art will readily understand how to apply the principles disclosed herein to virtually any desired type of object.

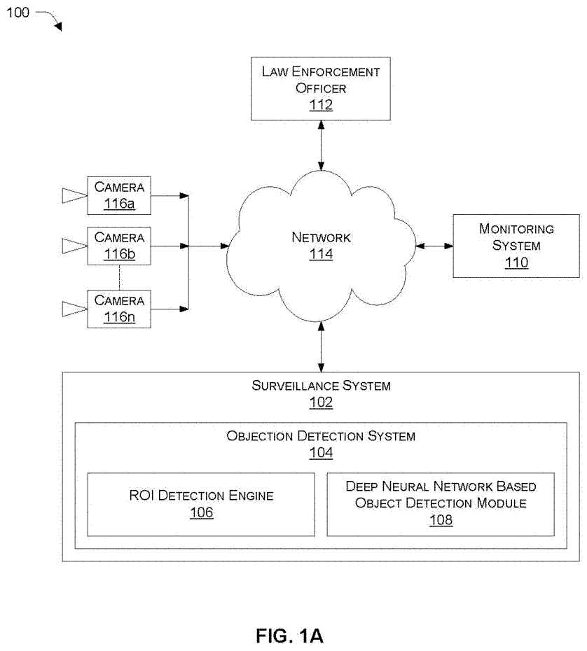

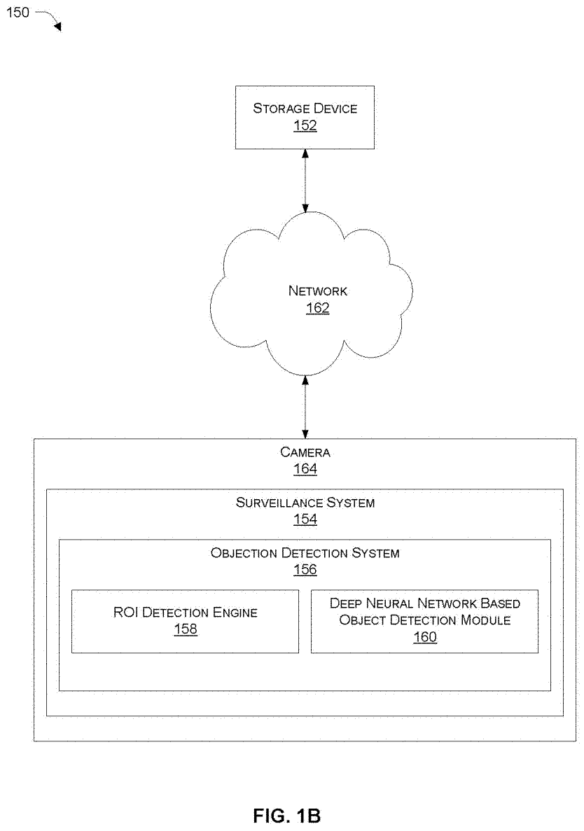

FIG. 1A illustrates an example network environment in which an object detection system 104 is deployed for accelerated processing in accordance with an embodiment of the present disclosure. A surveillance system 102 receives through a network 114, video feeds (also referred to as video frames) from one or more cameras (e.g., camera 116a, camera 116b, camera 116n) installed at different locations. The cameras 116a-n may capture high-resolution video frames (e.g., 1280×720, 1920×1080, 2560×1440, 2048×1536, 3840×2160, 4520×2540, 4096×3072 pixels, etc.) at high frame rates. The video frames captured by the cameras 116a-n may be input to the object detection system 104, which is operable to detect objects (e.g., a human face) and recognize the objects (e.g., facial recognition). Different entities, such as camera 116a-n, surveillance system 102, and monitoring system 110, may be implemented by different computing devices connected through network 114, which may be a LAN, WAN, MAN, or the Internet. Network 114 may include wired and wireless networks and/or connection of networks.

According to one embodiment, the video feeds received from each of these cameras may be separately analyzed to detect the presence of an object or an activity. The object detection system 104 of the surveillance system 102 may analyze the video feed at issue to detect the presence of one or more objects and may then match the objects with a database of existing images to recognize these objects. In the context of the present example, the object detection system 204 includes a region of interest (ROI) detection engine 106 operable to detect ROIs in video frames and to feed the ROIs extracted from the video frames to a machine learning model (e.g., a Deep Neural Network (DNN) based object detection module 108) designed for a specific purpose. Instead of passing the entirety of the video frames to the machine learning model, in accordance with various embodiments described herein, the object detection engine 106 feeds only the ROIs extracted from the video frames to the machine learning model. For its part, the DNN based object detection module 108 analyzes the ROIs to recognize an object present in the ROIs. For example, the DNN based object detection module 108 may receive ROIs from the ROI detection engine 106 and detect the presence of a human face and recognize the individual at issue.

In accordance with one embodiment, responsive to receipt of the video frames, the ROI detection engine 106 preprocesses the video frames for a stable and reliable result. The preprocessing may include one of more of converting Red, Green, Blue (RGB) values of each pixel of the video frames to grayscale, performing smoothing of the video frames, and performing whitening of the video frames. RGB video frames can be viewed as three images (a red scale image, a green scale image, and a blue scale image) overlapping each other. The RGB video frame can be represented as a three dimensional (3D) array (e.g., of size M×N×3) of color pixels, where each color pixel is a triplet, which corresponds to the red, blue and green color component of the RGB video frame at a specific location. These 3D arrays of color pixels may be converted to a two dimensional (2D) array of grayscale values. The grayscale frame can be viewed as a single layer frame, which is basically an M×N array. The engine 106 may also perform image smoothing (also referred to as image blurring) by convolving each video frame with a low-pass filter kernel. Image smoothing removes high-frequency content (e.g., noise, edges, etc.) from an image. Different smoothing techniques, such as averaging, gaussian blurring, median blurring, bilateral filtering, etc., can be used depending on the particular implementation, the environment from which the video feeds are received, and/or the intended use (e.g., object detection, face recognition, etc.). In an embodiment, engine 106 may apply different smoothing techniques for different sources of video frames, and different usage scenarios. Engine 106 may perform whitening, also referred to as Zero Component Analysis (ZCA), of the video frames to reduce correlation among raw data. In an embodiment, engine 106 may use pre-whitening to scale dynamic ranges of image brightness. The engine 106 may also use linear prediction to predict slow time-varying illumination.

Following the pre-processing stage, the ROI detection engine 106 may partition each video frame into cells of equal sizes, dimensions of which can be predetermined or configurable. For example, the engine 106 may overlay a virtual grid of cells on the preprocessed video frames to partition the video frames into multiple cells. For example, each video frame may be partitioned into cells of dimension X×Y (e.g., in which X and Y are multiples of 3).

The ROI detection engine 106 may then compare each cell of a video frame with the corresponding cell of one or more preceding or subsequent video frames to identify background cells, which are further used to identity foreground cells (that may also be referred to as active cells, which when aggregated may represent various ROIs within a video frame). Each cell of the video frame can be analyzed with respect to the corresponding cell of the other video frames to detect whether the cell is a background cell or an active cell having motion. This cell-based approach provides more stable and efficient detection of an active region than a pixel-based approach. The ROI detection engine 106 may further perform background learning by analyzing cells. For example, if a cell is inactive for a predetermined or configurable time period or number of frames, the cell is considered as a background cell. The engine 106 may estimate static or slow-varying background cells from video frames. In an embodiment, engine 106 may use learning prediction and perform smoothing (as described earlier) to mitigate the effect of illumination variation and noise. By comparing the background cells, engine 106 may further detect active cells.

Engine 106 may further cluster nearby active cells into a predetermined or configurable number of clusters to avoid producing a fragmented ROI result. In an embodiment, engine 106 uses K-means clustering to cluster nearby active cells. The resulting clusters may represent the regions of interest (ROI) and may be cropped from the original video frame. The engine 106 may then feeds the cropped ROIs to the deep neural network-based object detection module 108 for facial recognition. In an embodiment, prior to cropping, the engine 106 may merge overlapping ROIs and send the ROIs to module 108. The DNN based object detection module 108 may detect a human face from the ROIs and perform facial recognition. The surveillance system 102 may be used for multiple purposes, depending on different usage scenarios. For example, a monitoring system 110 (e.g., CCTV control room) may use the object detection system 104 to obtain a highlighted view of identified objects and faces. In an embodiment, a person may be marked as a person of interest. System 104 can trigger a notification to the monitoring system 110 or law enforcement office 112 (if required) when system 104 detects the presence of a person of interest in a video feed.

The video surveillance system 102 may be used, for among other purposes, to help organizations create safer workplaces to protect employees, safeguard properties, and prevent losses from insider threats, theft, and/or vandalism. In an embodiment, system 102 can be used to unify video surveillance and physical security management with one integrated platform. Video feeds received from the cameras 116a-n can be stored on network storage (cloud storage) or centralized storage in its raw form or with the highlights of the identified objects/human faces. For example, the objects or human faces can be tagged with the recognized identity information. Appropriate metadata, if desired, can be added to the video frames, which can be displayed while replaying the video frames.

FIG. 1B illustrates the deployment of an object detection system on an edge device for accelerated processing in accordance with an embodiment of the present disclosure. As shown in FIG. 1B, a surveillance system 154 may be integrated with a camera 164 (an edge device). The system 154 may store the video feeds received from the integrated camera and perform the object detection and facial recognition locally. The system 154 may include local storage or use storage device 152 or cloud storage infrastructure connected through a network 162 for storing the video feeds. Camera 164, which is an edge device, may be configured to perform face recognition using the teachings of present disclosure locally. The camera may be a CCTV camera, or a handheld imaging device, or an IoT device, or a mobile phone integrated camera that captures video. Videos captured by the camera 164 can be analyzed by the object detection system 156 to detect the presence of different objects and/or perform face recognition. The camera 164 may be configured to perform a majority of processing locally and recognize a face even when it is not connected to the network 162. The camera 164 may upload raw videos and analyzed video feeds to the storage device 152 when connected with the network 162. In this manner, the object detection system 156 may be optimized for edge computing.

The surveillance system 154 retrieves reference images through network 162 that it may use to recognize face detected from the captured video feed. The retrieved reference images may be stored locally with a memory unit connected with the camera 164. The DNN based object detection module 160 performs object detection (e.g., detection of a human face) and facial recognition in video feeds captured by the camera 164. By performing the majority of the image analysis steps for facial recognition closer to the origin of data (video feed), the object detection system may gain further efficiency and also removes network dependency. In addition to lowering the cost of networking infrastructures, edge computing reduces edge-cloud delay, which is helpful for mission-critical applications. As the surveillance system, 154 can be deployed in different environments with mission-critical end applications, edge computing of facial recognition may provide an extra edge.

On receiving video feeds from camera 164, the ROI detection engine 158 of the object detection system 156 extracts ROIs from the video feed and passes the ROIs to DNN based object detection module 160. The DNN based object detection module 160 detects objects in the cropped ROI submitted to it and recognizes a face contained therein. For example, module 160 may detect a human face in cropped ROIs and match the human face against a database of faces. Facial recognition can be used to authenticate a user, recognize and/or track a suspicious person throughout video feeds captured by one or more video cameras. The recognized faces across multiple video frames capture by different video cameras can be time traced along with location data of the cameras to track the activity of a particular person of interest.

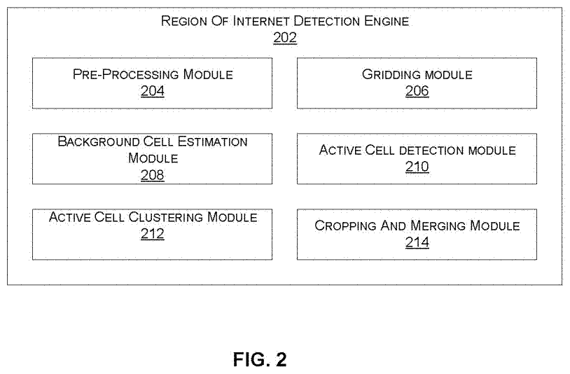

FIG. 2 illustrates functional modules of an object detection system in accordance with an embodiment of the present disclosure. In the context of the present example, instead of feeding the entirety of raw video frames to a DNN-based facial recognition module (a DNN based object recognition module with a specific application for facial recognition), only cropped ROIs are fed to the DNN-based facial recognition module. An ROI detection engine 202 includes a preprocessing module 204 operable to perform image smoothing, whitening, and conversion of RGB video frames to grayscale video frames, a gridding module 206 operable to partition each video frame of the multiple video frames into cells, a background cell estimation module 208 operable to estimate background cells by comparing each cell of a video frame with the corresponding cell of the other video frames of the multiple video frames, and an active cell detection module 210 operable to detect active cells based on the estimated background cells. An object recognition system of the surveillance system may perform preprocessing and extraction o ROIs, and then in order to boost model accuracy and efficiency the deep neural network for facial recognition may be fed with only a subset of the video frames (e.g., the preprocessed ROIs extracted therefrom).

According to one embodiment, the pre-processing module 204 performs preprocessing of video frames including converting the RGB video frames to grayscale video frames, smoothing the video frames, and whitening the video frames. The grayscale video frames avoid distraction to the DNN. Video frames captured by a camera are generally colored video frames, which are represented as RGB video frames. Each colored image (also referred to as a video frame) can be viewed as three images (a red scale image, a green scale image, and a blue scale image) overlapping each other. For converting RGB video frames, a 3D array of color pixels representing a video frame is converted to a 2D array of grayscale values. There are various approaches for converting a color image to a grayscale image. One approach involves, for each pixel of the image, taking the average of the red, green, and blue pixel values to produce a grayscale value. This combines the lightness or luminance contributed by each color band into a reasonable gray approximation. The grayscale frame can be viewed as a single layer frame, which is basically a M×N array, in which low numeric values indicate darker shades and higher values indicate lighter shades. The range of pixel values is often 0 to 255, which may be normalized to a range of 0 to 1 by dividing by 255.

The processing module 202 may also perform image smoothing by convolving each video frame with a low-pass filter kernel. Image smoothing may involve the removal of high-frequency content (e.g., noise, edges, etc.) from an image. Different smoothing techniques, such as averaging, gaussian blurring, median blurring, bilateral filtering, etc., can be used depending on the environment from which the video feeds was received and the intended usage scenario. The preprocessing module 204 may further perform whitening of the video frames to get rid of correlation among raw data. Depending on the environment in which the video frames are captured, one or more preprocessing steps can be performed and altered to obtain better results.

In one embodiment, the gridding module 206 of the ROI engine 202 partitions each video frame of the multiple video frames into cells of equal sizes. Each cell may represent an X×Y rectangular block of the pixels of the video frame. As those skilled in the art will appreciate, the size of the cells impacts the speed of ROI detection and quality of ROI detection. Smaller cells size may lead to computational delay, while larger cell size may lead to lower quality. Based on the size of the video frames at issue, an appropriate cell size may be determined empirically. In one embodiment, X and Y are multiples of three, which may produce non-limiting examples of cells of size 3×6, 15×18, 27×27, 30×60, etc. Empirical evidence suggests a cell size of 30×60 pixels produces good performance. The cells may be used for detecting background areas (referred to as background cells) and detecting foreground areas (referred to as foreground cells or active cells) by, for example, comparing cells of a video frame with the corresponding cells of other video frames. It has been observed that cell-based comparison provides better efficiency in terms of faster facial recognition as compared to pixel-based analysis.

In an embodiment, the size of cells previously identified as ROIs may be further be reduced. For example, some cells of a video frame may be partitioned into a size of 30×60, while earlier identified ROIs are partitioned into cells of size 15×30. Using the variable cell partitioning method, more active regions of interest can be identified with better clarity. For the specific application of ROI detection and facial recognition, however, video frames are partitioned into cells of equal size.

The background cell estimation module 208 is responsible for identifying background cells. According to one embodiment the background cell estimation module 2088 compares each cell of a particular video frame with corresponding cells of other video frames. If the content of a particular cell remains unchanged for a predetermined or configurable number of frames, the cell is considered to be a background cell. In an embodiment, the grayscale values for each cell can be determined as an average of the grayscale value of its pixels and can be compared with a similarly identified grayscale value of corresponding cells in subsequent video frames. If the grayscale values of a cell and its corresponding cells of subsequent frames are the same for more than a threshold number of frames or for more than a threshold period of time, the cell can be considered as a background cell. Alternatively, other types of image comparisons may be performed to identify whether the two cells are identical. In one embodiment, if a variation of average intensity of a cell is small in 50˜100 frames, it can be considered as background. For each cell, a similar comparison can be performed, and background cells can be estimated. The background cell estimation module 208 may perform background learning to estimate static or slow-varying background cells from video frames. Learning prediction and smoothing techniques may be applied to mitigate the effect of illumination variation and noise. Module 208 may apply different smoothing techniques, such as exponential smoothing, moving average, double exponential, etc., to reduce or cancel illumination variation and noises while estimating background cells. Module 208 may be operable to use long term background learning. As those skilled in the art will appreciate, a slow variation of illumination will not affect long-term background learning in the proposed algorithm. Thus, the long term background learning-based background estimation becomes more suitable for surveillance systems where most of the background areas may be static or slow time-varying for a very long time.

Once the background cells are estimated, the active cell detection module 210 may detect active cells in comparison to the background cells. In an embodiment, a single module may perform the classification of background cells and active cells based on a comparison of cells and by applying long term background learning and smoothing techniques. Module 210 may detect active cells by comparing the cell with the estimated background cells.

In an embodiment, the active cell clustering module 212 is operable to group the active cells into a predetermined or configurable number of clusters. The active cell clustering module 212 may use a K-means clustering or equivalent algorithm. A K-means clustering is an unsupervised clustering technique used to segment the active cells from the background cells. It clusters or partitions the given data into K-clusters or parts based on K-centroids. As the raw data from video frames are unlabeled, K-means is identified to be a suitable clustering technique for the detection of ROIs. K-means clustering groups the data based on some kind of similarity in the data with a number of the group represented by K. In the present context of surveillance applications and facial recognition, example values of K found to be suitable are those between 2 and 5, inclusive. Other supervised and non-supervised clustering algorithms can also be used.

In the context of the present example, engine 202 also includes a cropping and merging module 214 operable to crop active cells, merge overlapping cells, and the extract ROIs. Once the active cells, also referred to as ROIs (after clustering), are determined, the ROIs are cropped and merged (wherever required) and are passed to the facial recognition DNN. The facial recognition DNN extracts facial features from the ROIs, detect the presence of a human face, and recognizes the human face. Based on the recognized face, the user can be authenticated, tracked, or highlighted through the video frames.

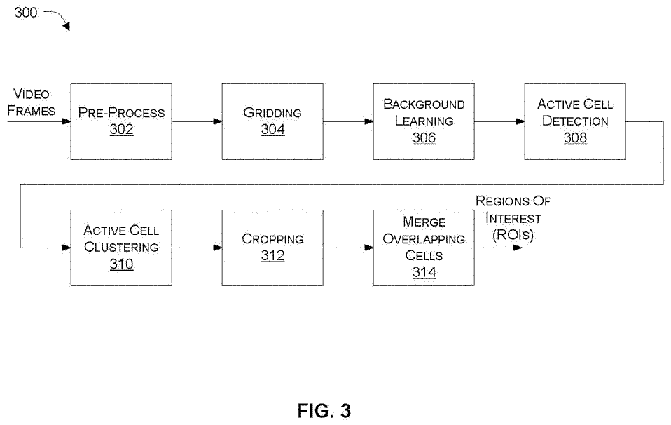

FIG. 3 is a block diagram 300 illustrating functional blocks for regions of interest identification, in accordance with an embodiment of the present disclosure. As shown in FIG. 3, the ROI detection module (e.g., the ROI detection engine 106, 158, or 202) receives video frames, preprocesses (as shown at block 302) the video frames, performs gridding (as shown at block 304) to partition each frame of the video frames into cells of equal sizes, performs background learning (as shown at block 306) to estimate background cells, and performs active cell detection (as shown at block 308) in comparison to estimated background cells. The ROI detection module may use a K-means clustering algorithm to cluster the active cells (as shown in block 310) into a predetermined or configurable number of ROIs. The module performs cropping (as shown at block 312) and merges overlapping cells (as shown at block 314) before sending the ROIs to the facial recognition DNN. Experimental results demonstrate the impact of cropping as used by the ROI detection engine. It has been observed that the time taken to recognize objects per frame is reduced significantly when cropping and other teachings of the present disclosure are applied to pre-detect ROIs. For example, when a set of videos were partitioned into three groups based on content activities, and their object detection speed was compared without applying the ROI pre-detection and cropping, it was observed that a high-density video that was previously taking 0.353 seconds per frame was now taking 0.035 seconds per frame using various features of the present disclosure. Similarly, a medium-density video that was previously taking 0.345 sec per frame without applying the ROI pre-detection and cropping was reduced to 0.003 sec per frame using various features of the present disclosure, and a low-density video that was previously taking 0.343 seconds per frame was reduced to 0.002 seconds per frame. In view of the foregoing, depending upon various factors, the pre-detection and cropping of ROIs and feeding of only the cropped ROIs to the face recognition DNN may reduce the time for performing face recognition by on the order of 3 to 10 times.

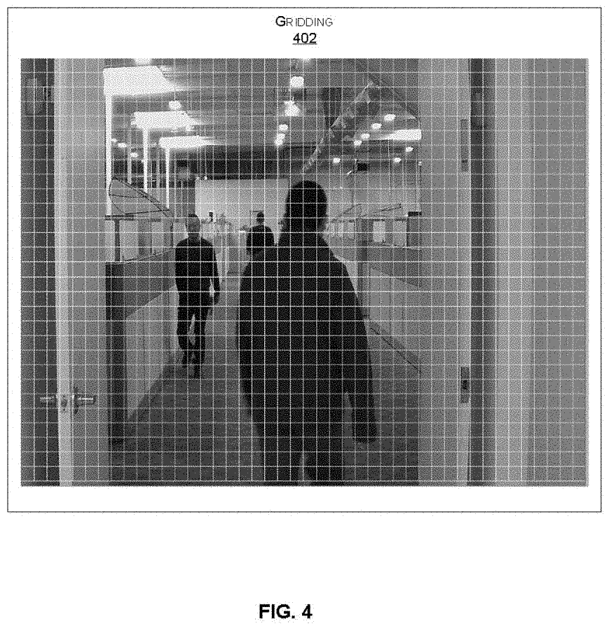

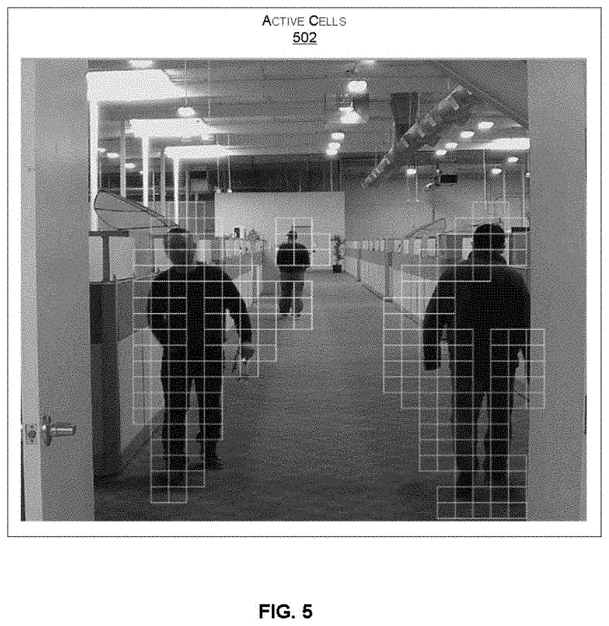

FIG. 4 illustrates grid cells created for further analysis in accordance with an embodiment of the present disclosure. In one embodiment, during gridding 402, a video frame is partitioned into rectangular cells of equal sizes. For example, the size of each cell may be 30×60 pixels. Depending on the resolution of input video frames, a suitable size of the cells can be determined empirically. As noted above, these cells may be used for estimating background and detecting active cells. FIG. 5 illustrates an example of active cells identified in accordance with an embodiment of the present disclosure. Depending on the comparison of a cell with corresponding cells of other previous and/or subsequent video frames, estimated background cells and active cells can be determined. In FIG. 5, highlighted cells (those outlined) represent the active cells 502.

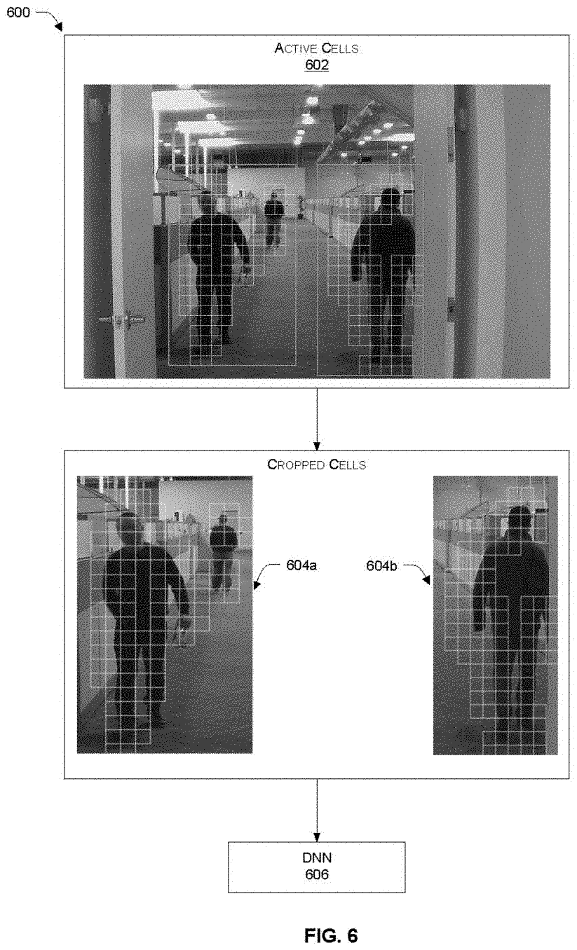

FIG. 6 illustrates the extraction of a predetermined or configurable number of regions of interest (ROIs) by cropping clusters of active cells and merging overlapping regions as appropriate in accordance with an embodiment of the present disclosure. As shown in the example, video frame 600, active cells 602 can be distributed across different locations. The ROI engine may group nearby cells apply a K-means clustering algorithm to cluster the active cells into K clusters. In the context of the present example, the active cells 602 are clustered into two clusters 604a and 604b. The clustered cells (604a and 604b) can then be cropped from the video frame 600 and passed to an object detection DNN 606. In an embodiment, the cropped cells can be merged if there are any overlapping regions before sending the ROIs to the DNN 606.

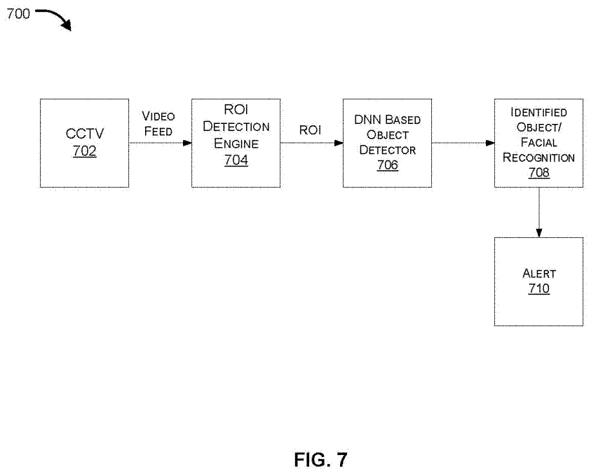

Although in the context of various examples, the ROI detection engine 202 is described with reference to object recognition and particularly for facial recognition, those skilled in the art will appreciate that the engine 202 can be used for various other applications. FIG. 7 illustrates an example application of the object detection system in accordance with an embodiment of the present disclosure. An ROI detection engine 704 receives a video feed captured by a closed-circuit television 702 (CCTV) camera and extracts ROIs from the video feed. The ROIs are passed to a DNN based object detector 706 to identify an object or perform facial recognition 708. Once the object is identified or the face is recognized, based on predefined policies in an integrated surveillance system, an alert 710 can be generated. Alert 710 may relate to the detection of a person listed in the lookout database. For typical object detection, alert 710 can also be generated for the presence of unwanted items (e.g., gun, knife, sharp object, ornament, valuable object), etc., if detected and recognized. In an embodiment, the video feed along with CCTV camera details, such as camera location, date of video capture, etc., can be sent with highlights of the identified and recognized face to a third party. The DNN based object detection system may also be used for user authentication. For example, using the ROI extracted from the video frames, the DNN based object detector 706 can recognize if a person present in the video frames is an authorized person.

The object detection system can be integrated with a physical security mechanism. Based on the recognized face from video frames, the physical security control devices may grant access to a secured location if the recognized face is of an authorized user. Integration of the object detection system (especially the facial detection system) with physical security control devices will provide an enhanced user experience, as the user doesn't have to wait in front of a secure control gate or barrier for recognizing him before granting access.

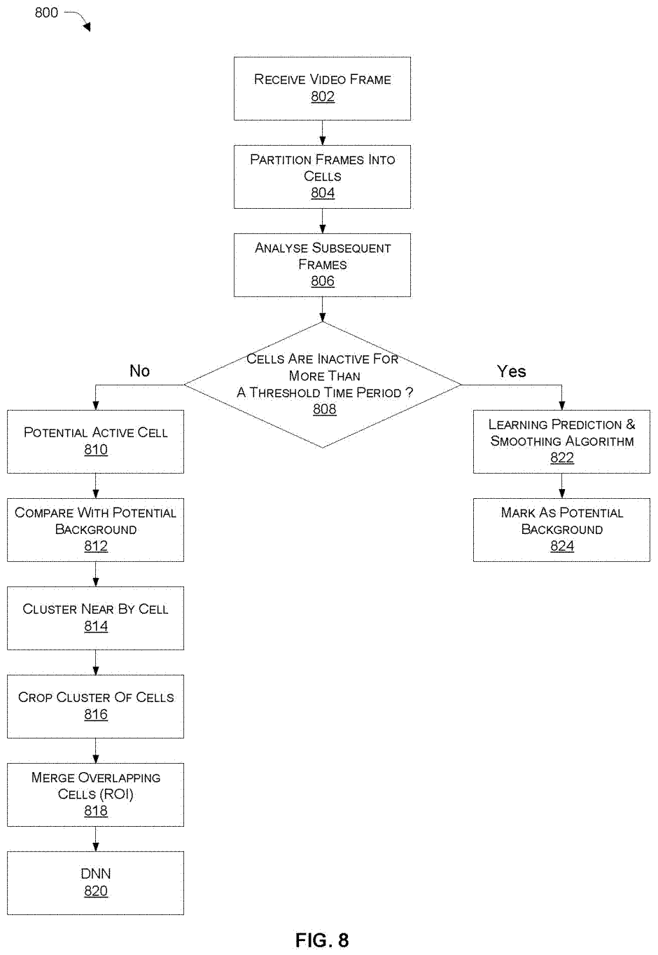

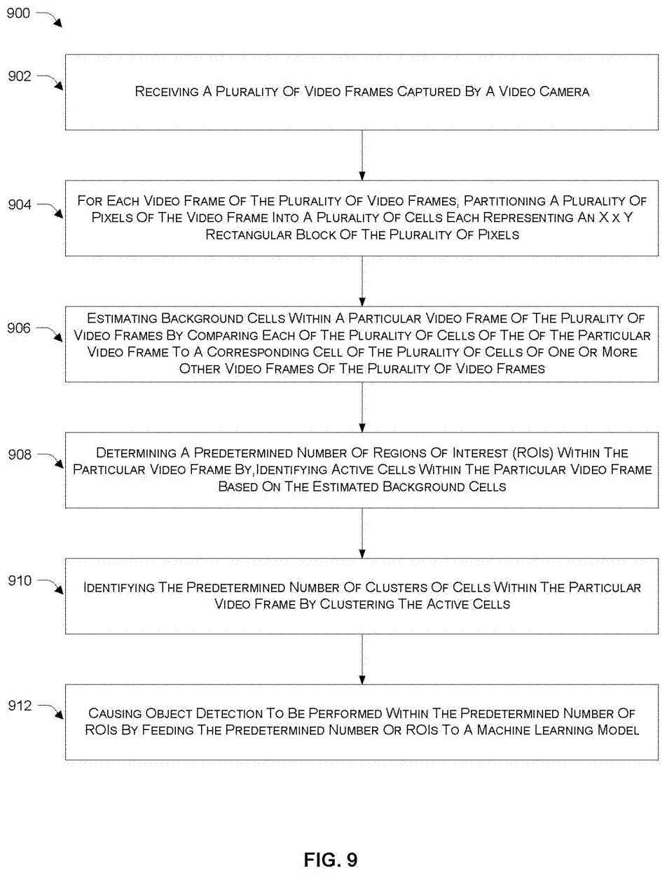

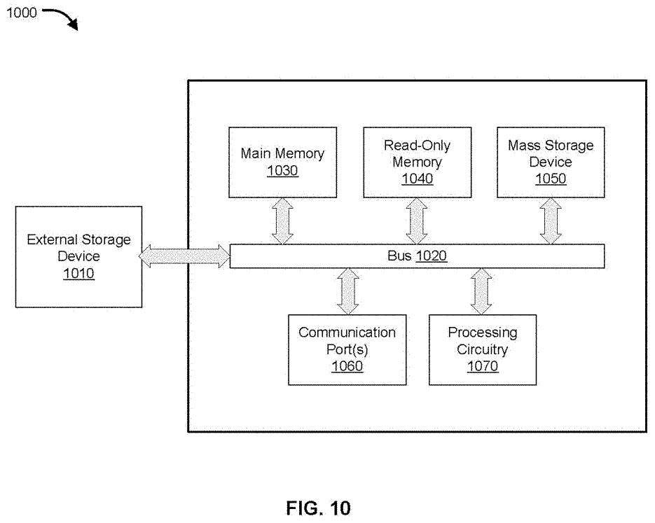

The various engines and modules (e.g., ROI detection engine 106 and DNN-based object detection module 108) and other functional units described herein and the processing described below with reference to the flow diagrams of FIGS. 8-9 may be implemented in the form of executable instructions stored on a machine readable medium and executed by a processing resource (e.g., a microcontroller, a microprocessor, central processing unit core(s), an application-specific integrated circuit (ASIC), a field programmable gate array (FPGA), and the like) and/or in the form of other types of electronic circuitry. For example, the processing may be performed by one or more virtual or physical computer systems of various forms, such as the computer system described with reference to FIG. 10 below.

FIG. 8 illustrates an example flow diagram or ROI extracting processing in accordance with an embodiment of the present disclosure. In one embodiment, the process flow 800 is performed by an object detection and recognition module (e.g., object detection system 104) of a surveillance system (e.g., surveillance system 102). In the context of the present example, the process 800, which may be used for the facial recognition, starts at block 802 in which the facial recognition system receives video frames. At block 804, each video frame is partitioned into cells of equal size. At block 806, subsequent video frames may be analyzed to estimate background cells and active cells. At decision block 808, it is determined whether cells have been active or greater than a predetermined or configurable amount of time or number of frames. In one embodiment, a cell is considered to be inactive if the cell of the video frame and the corresponding cells of the subsequent video frames have not changed for a threshold period of time or number of frames. If a particular cell satisfies the inactivity threshold, then processing branches to block 822; otherwise processing continues with block 810. Process 800, uses a learning prediction and smoothing algorithm, as shown at block 822, on inactive cells and marks the cells as potential background cells as shown at block 824. Cells that are active based on the determination shown at block 808 are marked as potential active cells, as shown at block 810. The cells are compared with estimated background cells, as shown at block 812, to identify active cells. The active cells are further clustered with nearby cells, as shown in block 814. In an embodiment, K-means clustering is used for clustering the active cells. The process 800 further crops the clusters of cells as shown at block 816 and merges overlapping cells as shown at block 818. The merged, cropped and clustered cells (referred to as ROIs) may then be sent to DNN 820.

FIG. 9 is a flow diagram illustrating accelerated object detection processing in accordance with an embodiment of the present disclosure. The flow 900 includes the steps of receiving a plurality of video frames captured by a video camera as shown at block 902, for each video frame of the plurality of video frames, partitioning a plurality of pixels of the video frame into a plurality of cells, each representing an X×Y rectangular block of the plurality of pixels as shown at block 904 and estimating background cells within a particular video frame of the plurality of video frames by comparing each of the plurality of cells of the particular video frame to a corresponding cell of the plurality of cells of one or more other video frames of the plurality of video frames as shown at block 906. The flow 900 further includes steps of determining the number of regions of interest (ROIs) within the particular video frame by identifying active cells within the particular video frame based on the estimated background cells as shown at block 908 and identifying the number of clusters of cells within the particular video frame by clustering the active cells as shown at block 910. The flow 900 further causes an object detection to be performed within the number of ROIs by feeding the number of ROIs to a machine learning model, as shown in block 912.

FIG. 10 illustrates an exemplary computer system 1000 in which or with which embodiments of the present disclosure may be utilized. As shown in FIG. 10, the computer system includes an external storage device 1040, a bus 1030, a main memory 1020, a read-only memory 1020, a mass storage device 1025, one or more communication ports 1010, and one or more processing resources (e.g., processing circuitry 1005). In one embodiment, computer system 1000 may represent some portion of a camera (e.g., camera 116a-n), a surveillance system (e.g., surveillance system 102), or an object detection system (e.g., object detection system 104).

Those skilled in the art will appreciate that computer system 1000 may include more than one processing resource and communication port 1010. Non-limiting examples of processing circuitry 1005 include, but are not limited to, Intel Quad-Core, Intel i3, Intel i5, Intel i7, Apple M1, AMD Ryzen, or AMD® Opteron® or Athlon MP® processor(s), Motorola® lines of processors, FortiSOC™ system on chip processors or other future processors. Processor 1070 may include various modules associated with embodiments of the present disclosure.

Communication port 1010 can be any of an RS-232 port for use with a modem-based dialup connection, a 10/100 Ethernet port, a Gigabit, 10 Gigabit, 25G, 40G, and 100G port using copper or fiber, a serial port, a parallel port, or other existing or future ports. Communication port 760 may be chosen depending on a network, such as a Local Area Network (LAN), Wide Area Network (WAN), or any network to which the computer system connects.

Memory 1015 can be Random Access Memory (RAM), or any other dynamic storage device commonly known in the art. Read only memory 1020 can be any static storage device(s) e.g., but not limited to, a Programmable Read Only Memory (PROM) chips for storing static information e.g. start-up or BIOS instructions for the processing resource.

Mass storage 1025 may be any current or future mass storage solution, which can be used to store information and/or instructions. Non-limiting examples of mass storage solutions include Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 1030 communicatively couples processing resource(s) with the other memory, storage and communication blocks. Bus 1030 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processing resources to software system.

Optionally, operator and administrative interfaces, e.g., a display, keyboard, and a cursor control device, may also be coupled to bus 1030 to support direct operator interaction with computer system. Other operator and administrative interfaces can be provided through network connections connected through communication port 1060. External storage device 604 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

While embodiments of the present disclosure have been illustrated and described, numerous modifications, changes, variations, substitutions, and equivalents will be apparent to those skilled in the art. Thus, it will be appreciated by those of ordinary skill in the art that the diagrams, schematics, illustrations, and the like represent conceptual views or processes illustrating systems and methods embodying various non-limiting examples of embodiments of the present disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing the particular embodiment. Those of ordinary skill in the art further understand that the exemplary hardware, software, processes, methods, and/or operating systems described herein are for illustrative purposes and, thus, are not intended to be limited to any particular named. While the foregoing describes various embodiments of the disclosure, other and further embodiments may be devised without departing from the basic scope thereof.

What is claimed is:

1. A surveillance system comprising:
a video camera;
a processing resource;
a non-transitory computer-readable medium, coupled to the processing resource, having stored therein instructions that when executed by the processing resource cause the processing resource to:
receive a plurality of video frames captured by the video camera;
for each video frame of the plurality of video frames, partition a plurality of pixels of the video frame into a plurality of cells each representing an X×Y rectangular block of the plurality of pixels;
estimate background cells within a particular video frame of the plurality of video frames by comparing each of the plurality of cells of the particular video frame to a corresponding cell of the plurality of cells of one or more other video frames of the plurality of video frames;
detect a number of regions of interest (ROIs) within the particular video frame by:
identifying active cells within the particular video frame based on the estimated background cells; and
identifying the number of clusters of cells within the particular video frame by clustering the active cells; and
cause object detection to be performed within the number of ROIs by feeding the number of ROIs to a machine learning model.

2. The surveillance system of claim 1, wherein the instructions further cause the processing resource to prior to the object detection, crop each ROI of the number of ROIs.

3. The surveillance system of claim 2, wherein the instructions further cause the processing resource to merge overlapping portions, if any, of the number of ROIs.

4. The surveillance system of claim 1, wherein the instructions further cause the processing resource to prior to partitioning, preprocess the plurality of video frames.

5. The surveillance system of claim 4, wherein preprocessing of the plurality of video frames comprises for each video frame of the plurality of video frames:
converting Red, Green, Blue (RGB) values to grayscale;
performing image smoothing; and
performing whitening.

6. The surveillance system of claim 1, wherein estimation of the background cells comprises determining those of the plurality of cells that are inactive for greater than a predetermined threshold of time or number of frames by comparing corresponding cells of the plurality of cells among the plurality of video frames.

7. The surveillance system of claim 1, wherein said clustering the active cells involves application of a K-means clustering algorithm and wherein K represents the number of ROIs.

8. The surveillance system of claim 1, wherein the object detection comprises facial recognition.

9. The surveillance system of claim 1, wherein X and Y are multiples of 3.

10. A method performed by one or more processing resources of a surveillance system, the method comprising:
receiving a plurality of video frames captured by a video camera;
for each video frame of the plurality of video frames, partitioning a plurality of pixels of the video frame into a plurality of cells each representing a rectangular block of the plurality of pixels;
estimating background cells within a particular video frame of the plurality of video frames by comparing each of the plurality of cells of the particular video frame to a corresponding cell of the plurality of cells of one or more other video frames of the plurality of video frames;
detecting a number of regions of interest (ROIs) within the particular video frame by:
identifying active cells within the particular video frame based on the estimated background cells; and
identifying the number of clusters of cells within the particular video frame by clustering the active cells; and
causing object detection to be performed within the number of ROIs by feeding the number of ROIs to a machine learning model.

11. The method of claim 10, further comprising prior to said causing object detection to be performed, cropping each ROI of the number of ROIs.

12. The method of claim 11, further comprising merging overlapping portions, if any, of the number of ROIs.

13. The method of claim 1, further comprising prior to said partitioning, preprocessing the plurality of video frames.

14. The method of claim 13, wherein the preprocessing comprises for each video frame of the plurality of video frames:
converting Red, Green, Blue (RGB) values to grayscale;
performing image smoothing; and
performing whitening.

15. The method of claim 10, wherein said estimating the background cells comprises determining those of the plurality of cells that are inactive for greater than a predetermined threshold of time or number of frames by comparing corresponding cells of the plurality of cells among the plurality of video frames.

16. The method of claim 10, wherein said clustering the active cells involves application of a K-means clustering algorithm and wherein K represents the number of ROIs.

17. The method of claim 10, wherein the object detection comprises facial recognition.

18. A non-transitory computer-readable storage medium embodying a set of instructions, which when executed by one or more processing resources of a surveillance system, causes the one or more processing resources to perform a method comprising:
receiving a plurality of video frames captured by a video camera;
for each video frame of the plurality of video frames, partitioning a plurality of pixels of the video frame into a plurality of cells each representing a rectangular block of the plurality of pixels;
estimating background cells within a particular video frame of the plurality of video frames by comparing each of the plurality of cells of the particular video frame to a corresponding cell of the plurality of cells of one or more other video frames of the plurality of video frames;
detecting a number of regions of interest (ROIs) within the particular video frame by:
identifying active cells within the particular video frame based on the estimated background cells; and
identifying the number of clusters of cells within the particular video frame by clustering the active cells; and
causing object detection to be performed within the number of ROIs by feeding the number of ROIs to a machine learning model.

19. The non-transitory computer-readable storage medium of claim 18, wherein said estimating the background cells comprises determining those of the plurality of cells that are inactive for greater than a predetermined threshold of time or number of frames by comparing corresponding cells of the plurality of cells among the plurality of video frames.

20. The non-transitory computer-readable storage medium of claim 18, wherein said clustering the active cells involves application of a K-means clustering algorithm, wherein K represents the number of ROIs, and wherein the object detection comprises facial recognition.
